(19) United States
(12) Patent Application Publication
(10) Pub. No.: US 2026/0360861 A1
(43) Pub. Date: Nov. 12, 2026

(54) COOLING DEVICE FOR ELECTROCHEMICAL OR ELECTROTECHNICAL COMPONENTS

(71) Applicant: CARRAR LTD, Shahar Hanegev (IL)

(72) Inventors: Markus STEPHAN, Gnotzheim (DE); Christoph REICHARDT, Buchdorf (DE); Tom RIEDEL, Weißenburg i. Bay (DE); Werner RUPPERT, Langenaltheim (DE); Eitam FRIEDMANN, Meitar (IL); Bar BEN-HORIN, Yeruham (IL)

(21) Appl. No.: 19/134,648

(22) PCT Filed: Nov. 17, 2023
(86) PCT No.: PCT/EP2023/082294

§ 371 Date: May 30, 2025

(30) Foreign Application Priority Data
Dec. 2, 2022 (DE) 10 2022 131 994.6
Dec. 2, 2022 (DE) 20 2022 106 753.8
Mar. 10, 2023 (DE) 10 2023 106 091.0

(51) Int. Cl. H01M 10/6564; H01M 10/613; H01M 10/625; H01M 10/647; H01M 10/6551

(52) U.S. Cl. CPC H01M 10/6564; H01M 10/613; H01M 10/625; H01M 10/647; H01M 10/6551; H01M 2220/20

(57) ABSTRACT

The invention relates to a cooling device for electrochemical or electrotechnical components, comprising a component housing having a housing body and a cover, wherein the component housing is equipped with an inlet and an outlet, wherein an interior is provided in the component housing for receiving coolant, wherein the cover comprises a first cover element with an inside and an outside, wherein the first cover element has a semi-permeable element, wherein the cover comprises a second cover element with an inside and an outside, wherein a gap is formed between the outside of the first cover element and the inside of the second cover element, which gap is fluidically connected to the outlet. The invention also relates to a cooling system.

The invention relates to a device for cooling electrochemical or electrotechnical components. In particular, the invention relates to a cooling device for battery cells in moving apparatuses such as vehicles. Moreover, the invention relates to a cooling system.

According to the prior art, it is known that electrochemical or electrotechnical components operate optimally in a predefined temperature window. For components that evolve heat when they operate, the generated heat must be dissipated. Otherwise, overheating of the component may result which, depending on the component, can lead to mere malfunctions of the component or to safety-relevant states.

When multiple single cells are placed in a housing for a battery, it is advantageously known from EP 2 503 199 A1, for example, to cool this battery or battery system. Contact cooling is known in which the contact cooling may function as a pressureless system using water-based media, or as an air conditioner based on hydrofluorocarbons or carbon dioxide. In addition, a pressure compensation device for a battery system is known from EP 2 503 199 A1 which provides an open-pore element to compensate for pressure of a dead volume in the battery system. The known element ensures gas exchange between the battery system and the atmosphere, in particular to avoid overpressure in the event of temperature fluctuations, and thus, damage to the battery system. Thus, this is a system in which gaseous fractions of coolant would be emitted to the atmosphere, resulting in a loss of coolant.

Another system for battery cooling is known from EP 3 113 279 A1, for example. A two-phase fluid is used in the known battery system. The gaseous coolant is either condensed in a topmost module of multiple modules, or is led to a condenser via a gas line. EP 3 113 279 A1 does not relate to the problem of retaining the liquid phase in the battery system, which is relevant in particular for electrochemical or electrotechnical components.

In particular when a two-phase fluid is to be used as coolant, it is advantageous when there is no connection between the cooling circuit and the atmosphere. To obtain an efficacious cooling effect, it is meaningful to discharge and recool only the gaseous fraction of the coolant.

The object of the invention is to provide a cooling device that remedies the above disadvantages according to the prior art. In particular, the aim is to provide a cooling device which selectively discharges a gaseous fraction of the coolant from the cooling device. A further aim is to provide a cooling system.

With regard to the device, the object is achieved by the features of claim 1. Advantageous embodiments result from the respective subclaims.

The cooling device according to the invention for electrochemical and electrotechnical components comprises a component housing having a housing body and a cover, wherein the component housing is equipped with an inlet and an outlet. An inner space for accommodating coolant is provided in the component housing. The cover includes a first cover element with an inner side and an outer side, wherein the first cover element has a semi-permeable element. The cover includes a second cover element with an inner side and an outer side, wherein a gap is formed between the outer side of the first cover element and the inner side of the second cover element, the gap being fluidically connected to the outlet. The gaseous coolant may be led from the inner space of the component housing, through the semi-permeable element of the first cover element, and into the gap, and from the gap may be led to the outlet.

In one embodiment, the component housing is made, at least in part, in particular of a plastic.

The outlet and the inlet each have an opening, and are advantageously provided for connecting a line or hose to each.

A semi-permeable element is understood in particular to mean an element that is permeable to a gas and is impermeable or at least hardly permeable to a liquid.

The housing body in particular has a trough-shaped design.

According to the invention, the cover has an at least two-part design. The first cover element in particular is designed in such a way that the first cover element lies flatly on the housing body, and the first cover element and the housing body delimit an inner space. The outlet and/or inlet are/is selectively provided in the cover or in the housing body. The second cover element covers at least the semi-permeable element and the gap, so that the component housing has a fluidic connection between the inner space and the surroundings solely via the inlet and the outlet.

The cooling device according to the invention has the advantage that coolant in the liquid phase remains in the inner space of the component housing, and coolant in the gaseous phase is selectively discharged from the inner space of the component housing.

The cooling device is also suited in particular for applications in which the component housing is subjected to changes in position or to accelerations, for example in a vehicle.

In one advantageous embodiment, the first cover element has at least one through hole with a circumferential edge, wherein a wall element extends along the circumferential edge, from the first cover element to the second cover element, and the wall element is formed at least in part by the semi-permeable element. The wall element or at least the semi-permeable element may be situated above the first cover element, i.e., on the side of the first cover element facing away from the inner space of the housing body. The semi-permeable element thus has a large distance from the coolant in the liquid phase, compared to a flat design of a semi-permeable element that is situated in the cover element.

In this embodiment, gaseous coolant initially passes through the opening and into a space, laterally bordered by the wall element, above the first cover element. The wall element may form one or more walls. The wall element is formed at least in part by a semi-permeable element, so that at least one area of the wall/walls is semi-permeable. Gaseous coolant can pass through the semi-permeable area and into the space between the first cover element and the second cover element that forms the gap. The gaseous coolant is then led through the gap and to the outlet.

In this embodiment, the distance between the liquid coolant in the housing body and the semi-permeable element is particularly great.

In a further embodiment, the wall element is formed entirely by the semi-permeable element.

In a further embodiment, the through hole has a circular shape and a wall element has a hollow cylindrical shape. The semi-permeable element is thus a ring-shaped or hollow cylinder-shaped element that is advantageously connected to the first cover element, and/or that rests on a circumferential edge of the through hole of the first cover element.

The semi-permeable element is advantageously a sinter element. As the result of using a sinter element as the semi-permeable element, only a small surface area is needed for the gas throughput, whereas alternative semi-permeable elements such as membranes or nonwovens require a significantly larger surface area.

The semi-permeable element, in particular a sinter element, may be connected to the first cover element in an integrally joined, force-fit, or form-fit manner.

Other fastening options known to those skilled in the art are also conceivable. The semi-permeable element may be designed as a plate-shaped element.

In one embodiment, the semi-permeable element is a plastic element, in particular made of sintered polyethylene (PE), polyethylene terephthalate (PET), or polytetrafluoroethylene (PTFE). The semi-permeable element and the cover element are advantageously made of the same material or a similar type of material. Such a material of the sinter element that is the same or of a similar type may be connected to the cover element in an integrally joined manner by welding, for example. Such an embodiment is particularly cost-effective to manufacture.

The first cover element advantageously includes one or more semi-permeable elements, in particular two to eight semi-permeable elements, in particular two to four semi-permeable elements. In particular, each semi-permeable element is a sinter element. The sinter elements are advantageously essentially identical. The sinter elements may have a pore size distribution that is matched to the coolant.

In one embodiment, the semi-permeable elements are situated in a, in particular each, corner area of the first cover element. In another embodiment, the semi-permeable elements are situated in two corner areas diagonally across from one another, for example.

The component housing, in particular the component body, may have a cuboidal design, and the first cover element and the second cover element may each have four corner areas.

In one embodiment, a surface area of the first cover element is smaller than that of the second cover element. The second cover element thus completely covers the first cover element.

In one embodiment, the gap may be flatly formed between the first and second cover elements. Alternatively or additionally, the first and/or second cover element may have protrusions that extend to the respective other cover element and delimit a width of the gap. One or more discharge channels that are connected to the outlet may be formed by the protrusions. Alternatively or additionally, the first and/or second cover element may have guide elements, for example in the form of channels or grooves, that lead a gas stream from the semi-permeable element to the outlet.

One or more battery elements or accumulator elements are advantageously accommodated in the component housing.

The component housing may have a safety element, for example in the form of a burst protection element and/or pressure relief valve.

According to a further aspect of the invention, a cooling system is disclosed which includes the cooling device, as well as a compressor and a radiator that are situated outside the component housing. The compressor and the radiator reliquefy the gaseous coolant. Alternatively, the cooling system may also include a heat exchanger or condenser that is situated outside the component housing and reliquefies the gaseous coolant. The cooling system forms a closed circuit.

The invention is explained in greater detail below with regard to further features and advantages, based on the description of exemplary embodiments and with reference to the appended drawings. The figures show the following, in each case in a schematic diagram:

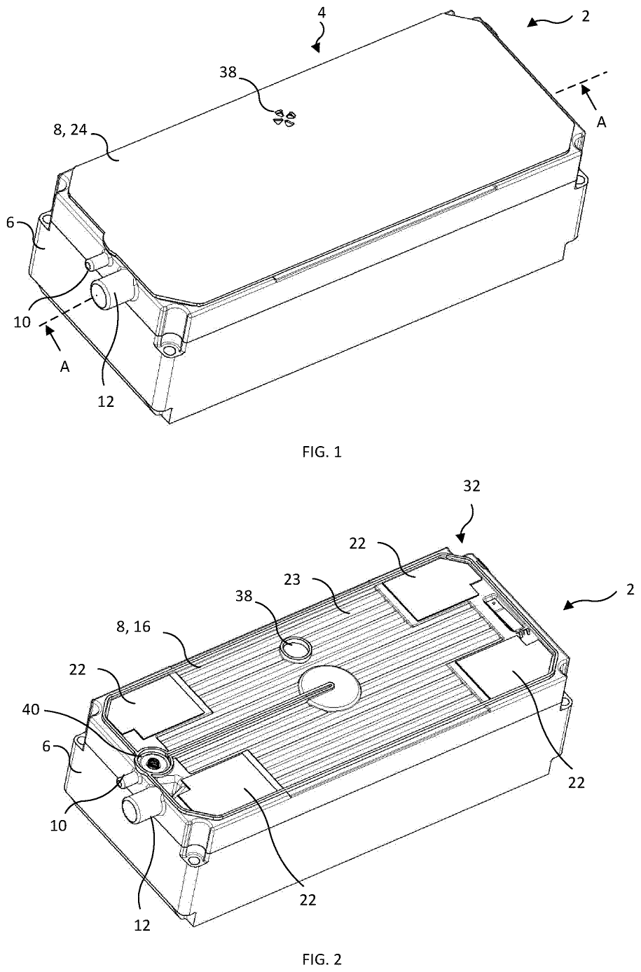

FIG. 1 shows a top view of a closed component housing,

FIG. 2 shows a top view of a partially open component housing of one embodiment,

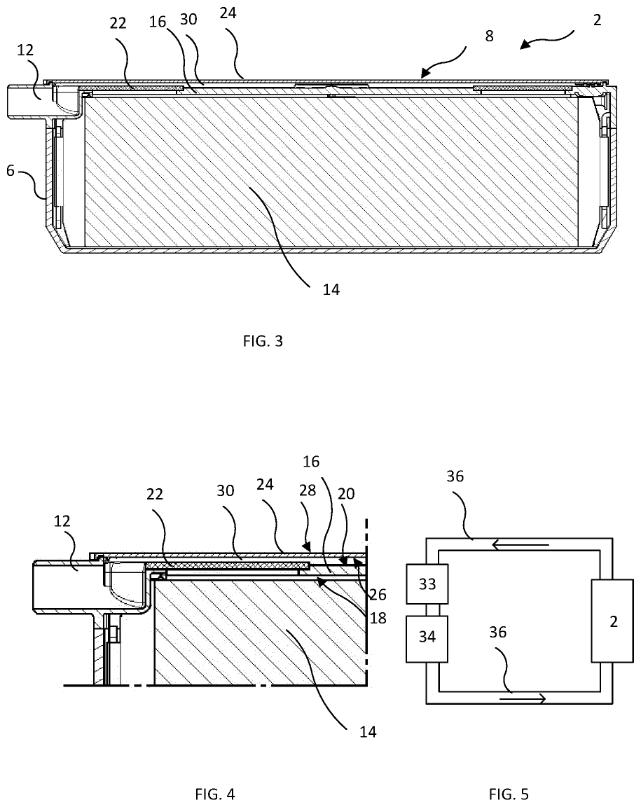

FIG. 3 shows a longitudinal section of a component housing of one embodiment along A-A according to FIG. 1,

FIG. 4 shows an enlarged detail from FIG. 3,

FIG. 5 shows a cooling system,

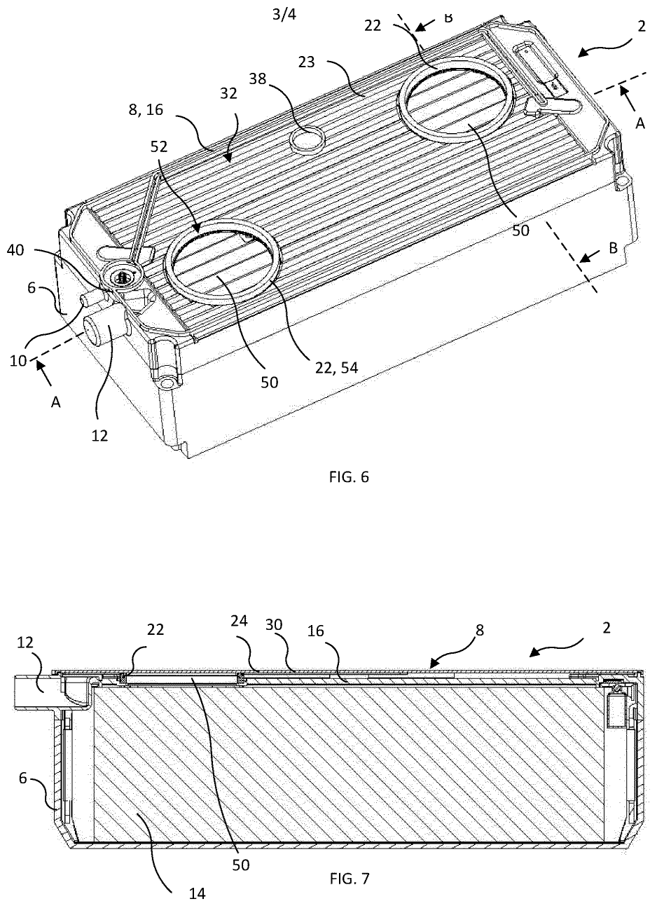

FIG. 6 shows a top view of a partially open component housing of a further embodiment,

FIG. 7 shows a longitudinal section of a component housing of one embodiment along A-A,

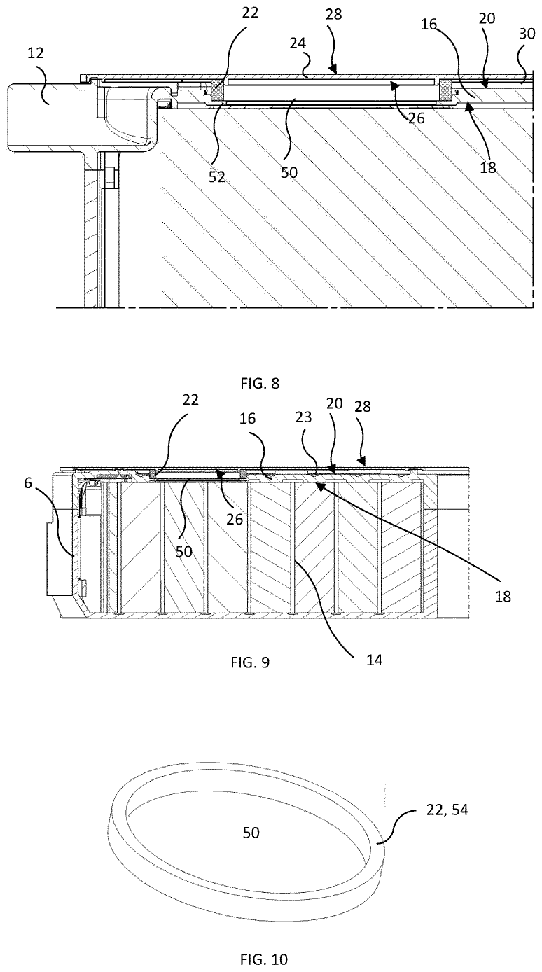

FIG. 8 shows an enlarged detail from FIG. 7,

FIG. 9 shows a cross section of a component housing of one embodiment along B-B, and

FIG. 10 shows a sinter element.

The cooling device 2 according to the invention comprises a component housing 4 (see FIG. 1). The component housing 2 has a housing body 6 and a cover 8. The housing body 6 has a trough-shaped design, and the cover 8 closes an inner space of the housing body 6. The component housing 2 is also provided with an inlet 10 and an outlet 12. In the embodiment shown, the inlet 10 and the outlet 12 each have a tubular protrusion. The cover 8 has a second cover element 24 on its top side. The second cover element 24 is provided with a safety element 38. The safety element 38 is in particular a burst protection element. In the embodiment illustrated in FIG. 1, the housing body 6 is essentially cuboidal.

In the component housing 4 illustrated in FIG. 2, the second cover element 24 is removed so that the first cover element 16 is visible. In the illustrated embodiment, the first cover element 16 has four semi-permeable elements 22, each situated in a respective corner of the first cover element 16. The four semi-permeable elements 22 are designed in particular as sinter elements, which preferably are connected in an integrally joined manner to a plate element of the first cover element 16. The first cover element 16 is likewise provided with a safety element 38, or the safety element 38 extends across the first and second cover elements 16, 24.

FIG. 3 shows a longitudinal section through FIG. 1 along A-A. An inner space 14 is present in the component housing 4, in particular the housing body 6. For example, battery cell elements may be accommodated in the inner space 14. Also accommodated in the inner space is a coolant, which may be partly liquid and partly gaseous. The inner space 14 is delimited with respect to a top side of the component housing 4 by a cover 8. The cover 8 includes a first cover element 16 and a second cover element 24. The first cover element 16 is situated facing the inner space 14, and the second cover element 24 is situated facing an outer top side of the cover 8. That is, an inner side 18 of the first cover element is oriented toward the inner space 14 and delimits the inner space 14. The outer side 20 of the first cover element 16 and the inner side 26 of the second cover element 24 lie opposite one another, and delimit a gap 30 that is situated between the first cover element 16 and the second cover element 24, as shown in particular in the enlarged illustration in FIG. 4. The first cover element 16 is provided with semi-permeable elements 22. The semi-permeable elements 22 have a plate-shaped design here. A gaseous coolant that is present in the inner space 14 passes from the inner space 14 and through the semi-permeable element(s) 22, and enters the gap 30. Guide elements in the form of channels are formed in the gap 30, on the outer side 20 of the first cover element 16, and lead a gas stream toward the outlet. The gaseous coolant 22 is led from the gap 30 to the outlet 12.

The cooling system according to the invention is illustrated in FIG. 5. The cooling device 2 with its outlet 12 is connected via a line 36 to a radiator 34 and a compressor 33, which reliquefy the gaseous coolant. The liquid coolant may then be resupplied to the cooling device 2 via a further line 36, so that the liquid coolant passes once again into the inner space 14 of the component housing via the inlet 10, for example by means of a valve 40. In the component housing, the coolant is reheated by the waste heat from components, in particular battery cells, accommodated in the component housing, and is at least partially converted into the gaseous phase. The gaseous coolant may be selectively discharged once again as described above, resulting in a closed cooling circuit. Multiple cooling devices, each of which is supplied with coolant, may also be situated in the cooling system, i.e., in the component housing.

FIG. 6 shows a further embodiment of the cooling device according to the invention. In the component housing 4 illustrated in FIG. 6, the second cover element 24 is removed so that the first cover element 16 is visible. In the illustrated embodiment the first cover element 16 has two semi-permeable elements 22, each situated in a respective corner of the first cover element 16. The two semi-permeable elements 22 are situated in diagonally opposite corners. The semi-permeable elements 22 are designed in particular as sinter elements that are connected in an integrally joined manner, for example, to a plate element of the first cover element 16.

The first cover element 16 has two through holes 50 here. Each of the through holes 50 has a circumferential edge 52 that is circular here. A wall element 54 that extends further, perpendicular to the first cover element 16, runs along the circumferential edge 52. The wall element 54 has a hollow cylindrical shape. The wall element 54 is in particular entirely a semi-permeable element that is designed as a sinter element, which has a hollow cylindrical design as shown in FIG. 10.

The first cover element 16 is likewise provided with a safety element 38, or the safety element 38 extends across the first and second cover elements 16, 24.

FIG. 7 shows a longitudinal section of the further embodiment along A-A. An inner space 14 is present in the component housing 4, in particular the housing body 6. Battery cell elements, for example, may be accommodated in the inner space 14. Also accommodated in the inner space is a coolant, which may be partly liquid and partly gaseous. The inner space 14 is delimited with respect to a top side of the component housing 4 by a cover 8. The cover 8 includes a first cover element 16 and a second cover element 24. The first cover element 16 is situated facing the inner space 14, and the second cover element 24 is situated facing an outer top side of the cover 8. That is, an inner side 18 of the first cover element is oriented toward the inner space 14 and delimits the inner space 14. The outer side 20 of the first cover element 16 and the inner side 26 of the second cover element 24 lie opposite one another, and delimit a gap 30 that is situated between the first cover element 16 and the second cover element 24, as shown in particular in the enlarged illustrations in FIGS. 8 and 9.

The first cover element 16 is provided with two semi-permeable elements 22. The semi-permeable elements 22 extend perpendicularly from the first cover element 16 to the second cover element 24. In particular, the semi-permeable element 22 rests on a circumferential edge 52 of the through hole 50 of the first cover element 16, and is thus situated on the outer side 20 of the first cover element 16 remote from the inner space 14. A gaseous coolant present in the inner space 14 passes from the inner space 14 and through the semi-permeable element(s) 22, and enters the gap 30. For this purpose, the gaseous coolant initially passes through the through hole 50 and is present in the space which is delimited by the wall element 54, and which is delimited with respect to the top side by the second cover element 24. The gaseous coolant can now pass through the wall element 54, formed from the semi-permeable element 22, in particular a sinter element, and pass into the gap 30. In the gap 30, guide elements 23 in the form of channels are formed on the outer side 20 of the first cover element 16, and lead a gas stream toward the outlet. These guide elements 23 are visible in particular in the sectional view in FIG. 9. The gaseous coolant 22 is led from the gap 30 and to the outlet 12.

### LIST OF REFERENCE NUMERALS

2 cooling device
4 component housing
6 housing body
8 cover
10 inlet
12 outlet
14 inner space
16 first cover element
18 inner side
20 outer side
22 semi-permeable element
23 guide element
24 second cover element
26 inner side
28 outer side
30 gap
32 corner area
33 compressor
34 radiator
36 lines
38 safety element
40 valve
50 through hole
52 circumferential edge
54 wall element

1. A cooling device for electrochemical and electrotechnical components, comprising
a component housing having a housing body and a cover, the component housing being equipped with an inlet and an outlet,
wherein an inner space for accommodating coolant is provided in the component housing,
wherein the cover includes a first cover element with an inner side and an outer side, the first cover element having a semi-permeable element,
wherein the cover includes a second cover element with an inner side and an outer side, a gap being formed between the outer side of the first cover element and the inner side of the second cover element, the gap being fluidically connected to the outlet,
wherein gaseous coolant may be led from the inner space of the component housing, through the semi-permeable element of the first cover element, and into the gap, and from the gap may be led to the outlet.

2. The cooling device according to claim 1, wherein the semi-permeable element is a sinter element.

3. The cooling device according to claim 1, wherein the semi-permeable element is a plastic element, in particular made of sintered PE, PET, or PTFE.

4. The cooling device according to claim 1, wherein the semi-permeable element and the first cover element are made of the same material or a similar type of material.

5. The cooling device according to one claim 1, wherein the first cover element includes multiple semi-permeable elements, in particular two to four semi-permeable elements.

6. The cooling device according to claim 5, wherein the semi-permeable elements are situated in a, in particular each, corner area of the first cover element.

7. The cooling device according to claim 1, wherein the component housing, in particular the component body, has a cuboidal design, and the first cover element and the second cover element each have four corner areas.

8. The cooling device according to claim 1, wherein a surface area of the first cover element is smaller than that of the second cover element.

9. The cooling device according to claim 1, wherein the semi-permeable element has a plate-shaped design.

10. The cooling device according to one of claim 1, wherein the first cover element has at least one through hole with a circumferential edge, wherein a wall element extends along the circumferential edge, from the first cover element to the second cover element, and the wall element is formed at least in part by the semi-permeable element.

11. The cooling device according to claim 10, wherein the wall element is formed entirely by the semi-permeable element.

12. The cooling device according to claim 10, wherein the through hole has a circular shape and the wall element has a hollow cylindrical shape.

13. The cooling device according to claim 1, wherein one or more battery elements or accumulator elements are accommodated in the component housing.

14. A cooling system that includes the cooling device according to claim 1, further including a radiator and a compressor that are situated outside the component housing.
